(19) United States
(12) Patent Application Publication
(10) Pub. No.: US 2026/0103950 A1
(43) Pub. Date: Apr. 16, 2026

(54) RIG FLOOR AUTOMATION USING STANDARD INDUSTRIAL HANDLING ROBOTS

(71) Applicant: Nabors Drilling Technologies USA, Inc., Houston, TX (US)

(72) Inventors: Ashish Gupta, Houston, TX (US); David Siljeg, The Woodlands, TX (US); Denver Lee, Houston, TX (US); Zachary Gonzales, Spring, TX (US)

(21) Appl. No.: 19/284,485

(22) Filed: Jul. 29, 2025

Related U.S. Application Data
(60) Provisional application No. 63/676,635, filed on Jul. 29, 2024.
(60) Provisional application No. 63/691,805, filed on Sep. 6, 2024.

(51) Int. Cl. E21B 19/14; B25J 11/00

(52) U.S. Cl. CPC E21B 19/14; B25J 11/0055

(57) ABSTRACT

A drilling rig apparatus includes first and second industrial handling robots, a catwalk, and a powered mousehole collectively configured for automated red zone tubular handling. One of the industrial handling robots is secured to the drilling rig floor while the other is mounted on a track that allows movement out of the way of manual tubular operations, optionally off the drilling rig floor. The catwalk lifts each tubular from a staging area into position for grasping by the track-mounted industrial handling robot, with an orientation closer to vertical than horizontal. The powered mousehole moves tubulars held therein up or down to facilitate assembly with additional tubulars by the industrial handling robots.

### CROSS-REFERENCE TO RELATED APPLICATIONS AND CLAIM FOR PRIORITY

This application claims priority to U.S. Provisional Patent Application No. 63/676,635 filed Jul. 29, 2024 and U.S. Provisional Patent Application No. 63/691,805 filed Sep. 6, 2024. The subject matter of the above-identified patent document(s) is incorporated herein by reference.

### TECHNICAL FIELD

This disclosure relates generally to drilling rig tubular handling automation. More specifically, this disclosure relates to cost-effective automation utilizing standard industrial handling robots for drilling rig tubular handling.

### BACKGROUND

Robotic mechanisms for automated pipe or casing (or “tubular”) handling on drilling rig systems are typically designed specifically for such purpose. Those robotic mechanisms are also typically designed according to the structure of and processes employed on the drilling rig system. This results in relatively expensive designs, despite the ready availability of less-expensive standard industrial handling robots.

### SUMMARY

A drilling rig apparatus includes first and second industrial handling robots, a catwalk, and a powered mousehole collectively configured for automated red zone tubular handling. One of the industrial handling robots is secured to the drilling rig floor while the other is mounted on a track that allows movement out of the way of manual tubular operations, optionally off the drilling rig floor. The catwalk lifts each tubular from a staging area into position for grasping by the track-mounted industrial handling robot, with an orientation closer to vertical than horizontal. Once a gripper on the track-mounted industrial handling robot engages around the tubular, the catwalk skate assembly may push the tubular through, so the final gripping position is closer to the lower portion of the tubular, for easier manipulation once robot holds the tubular in vertical position. The powered mousehole moves tubulars held therein up or down to facilitate assembly with additional tubulars by the industrial handling robots.

Other technical features may be readily apparent to one skilled in the art from the following figures, descriptions, and claims.

Unless defined otherwise herein, all technical and scientific terms used herein have the meaning as commonly understood by one of ordinary skill in the art within the context of the disclosure, and in the specific context where each term is used. Further, unless otherwise required by context, singular terms shall include pluralities and plural terms shall include the singular. It will further be understood that common terms and phrases, such as those defined in commonly-used dictionaries, should be interpreted as having a meaning that is consistent with their meaning in the context of the relevant art and should not be interpreted in an idealized or overly formal sense unless expressly so defined here. However, so that the present disclosure may be more readily understood, before undertaking the DETAILED DESCRIPTION below, it may be advantageous to set forth definitions of certain words and phrases used throughout this patent document. Therefore, certain terms are first defined, and additional definitions are set forth throughout the document.

The following definitions are provided in order to aid those skilled in the art in understanding the detailed description of the present disclosure. Unless otherwise defined herein, scientific and technical terms used in connection with the present invention shall have the meanings that are commonly understood by those of ordinary skill in the art to which this invention belongs.

The terms “include” and “including,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (i) including at least one A, (ii) including at least one B, or (iii) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element. The terms “connect,” “connected,” “contact,” “coupled,” and/or the like are broadly defined herein to encompass a variety of divergent arrangements and assembly techniques. These arrangements and techniques include, but are not limited to, (i) the direct joining of one component and another component with no intervening components therebetween (such as the components are in direct physical contact); and (ii) the joining of one component and another component with one or more components therebetween, provided that the one component being “connected to” or “contacting” or “coupled to” the other component is somehow in operative communication (such as electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected, or fluidly coupled may or may not be in direct physical contact, and one or more other components may be positioned therebetween.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some implementations of this disclosure but not to limit the scope of other implementations of this disclosure. The articles “a”, “an”, and “the” may be employed in connection with various elements and components of compositions, processes or structures described herein, and unless specifically indicated otherwise, are intended to include plural alternatives, e.g., at least one. It is to be understood that the singular forms “a,” “an,” and “the” include plural references unless the context clearly dictates otherwise. The term “plurality” refers to more than one element. That is, as used herein, the term “plurality” is intended to mean a population of two or more different members. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The terms “substantially,” “approximately,” “about,” “relatively,” or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, fluctuations can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Definitions for other certain words and phrases may be provided throughout this document. Those of ordinary skill in the art should understand that in many if not most instances, such definitions apply to prior as well as future uses of such defined words and phrases. In some cases, the terms and phrases defined here may be interpreted to exclude implementations of this disclosure.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller” within a claim is understood to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIGS. 1, 2, 3, 4, 7, and 8 are perspective views, and FIGS. 5 and 6 are side elevation views, individually and collectively illustrating one or more aspects of a drilling rig apparatus in accordance with the present disclosure;

FIG. 9 is a high level diagram for a process of employing at least one movable robot 103 on the drilling rig apparatus 100 in accordance with the present disclosure;

FIG. 10 is a high level diagram for a process of employing industrial handling robots 102 and 103 on the drilling rig apparatus 100 to make up tubular assemblies in accordance with the present disclosure;

FIGS. 11-12 and 14-15 are perspective views, and FIG. 13 is a side elevation view, individually and collectively illustrating one or more aspects of a drilling rig apparatus in accordance with the present disclosure;

FIGS. 16-22 individually and collectively illustrating one or more aspects of utilizing standard industrial handling robots for tripping and for racking/unracking on a drilling rig apparatus in accordance with the present disclosure;

FIGS. 23-24 individually and collectively illustrating one or more aspects of utilizing standard industrial handling robots in an alternative configuration for tripping and racking/unracking on a drilling rig apparatus in accordance with the present disclosure; and

FIGS. 25-32 individually and collectively illustrating one or more aspects of utilizing standard industrial handling robots for stand building on a drilling rig apparatus in accordance with the present disclosure.

### DETAILED DESCRIPTION

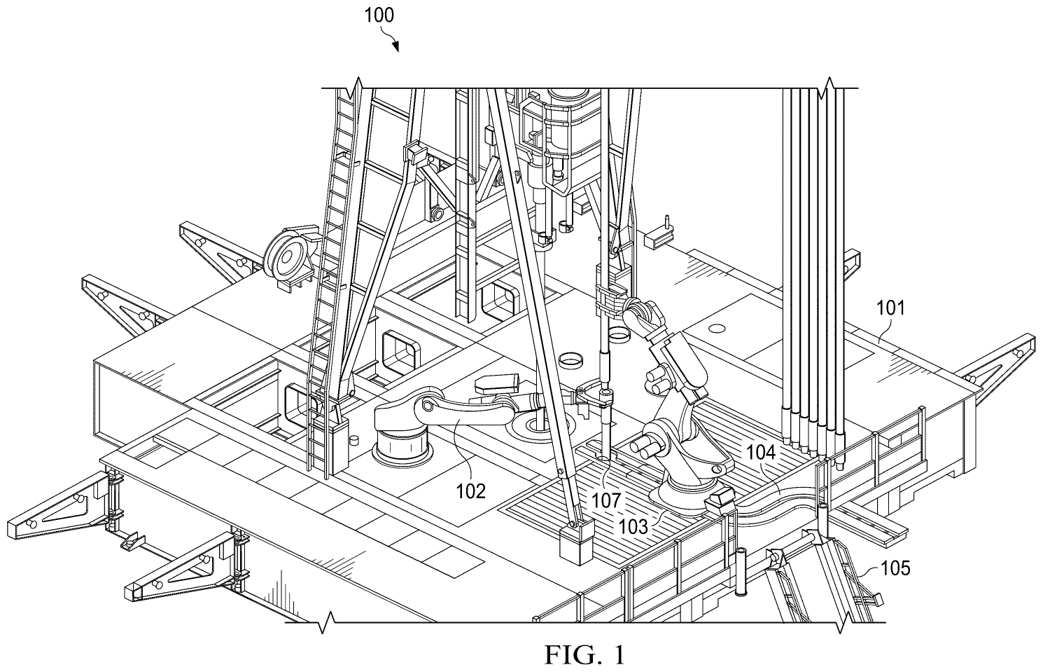

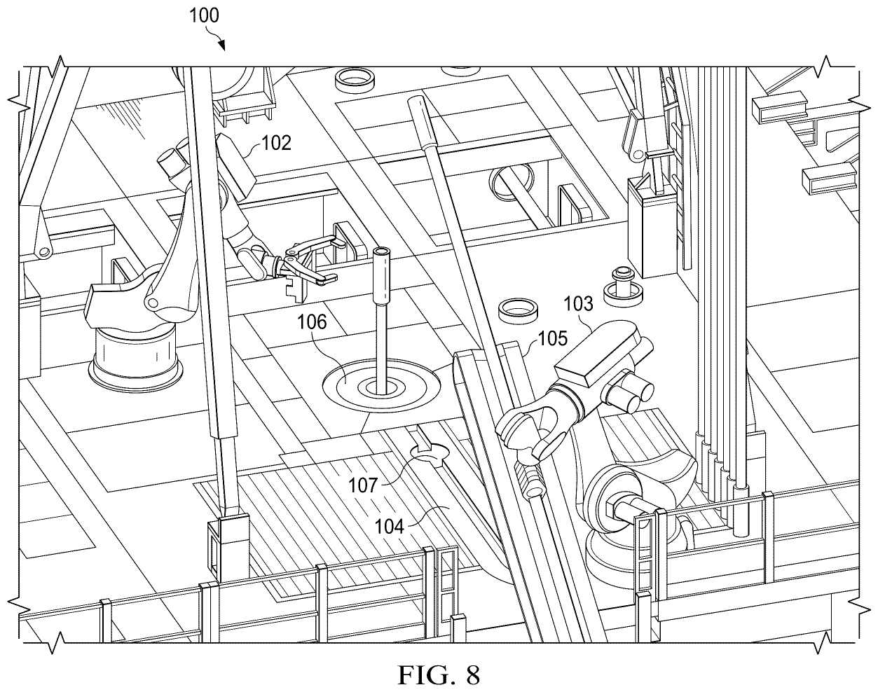

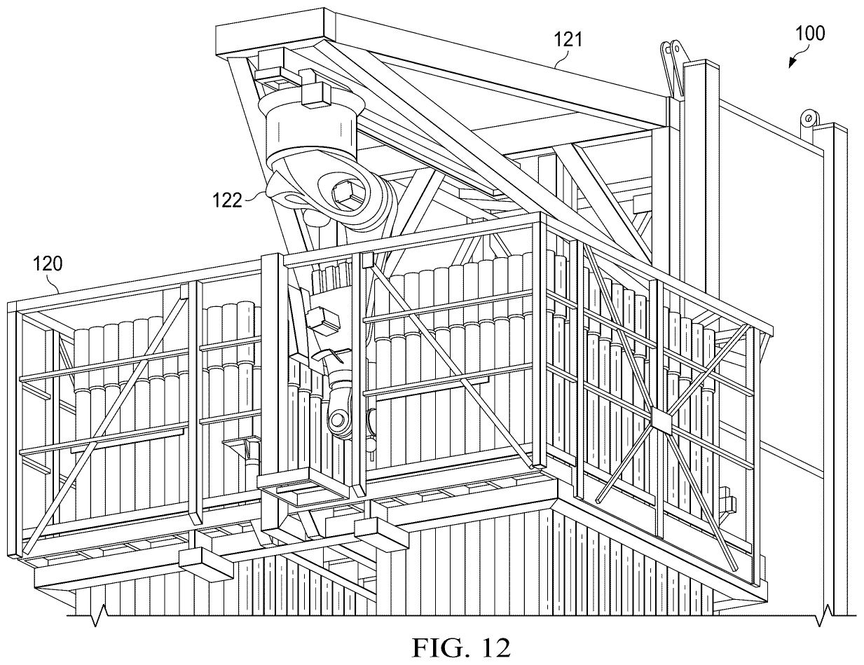

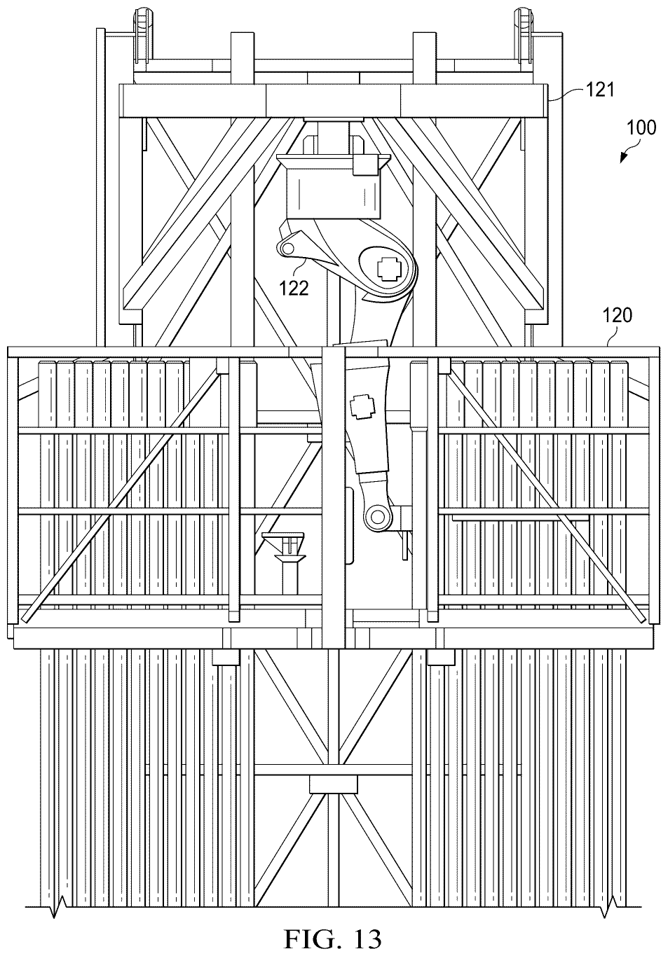

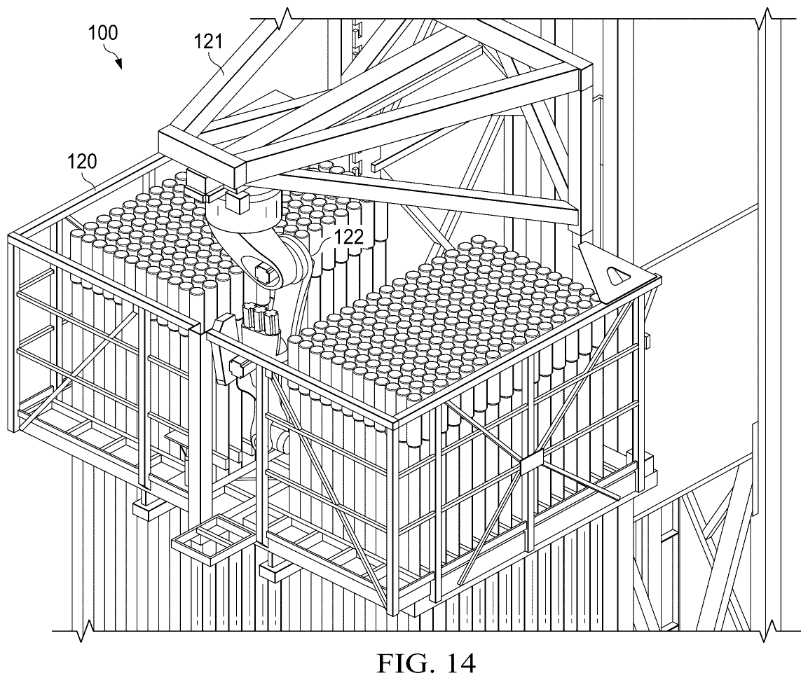

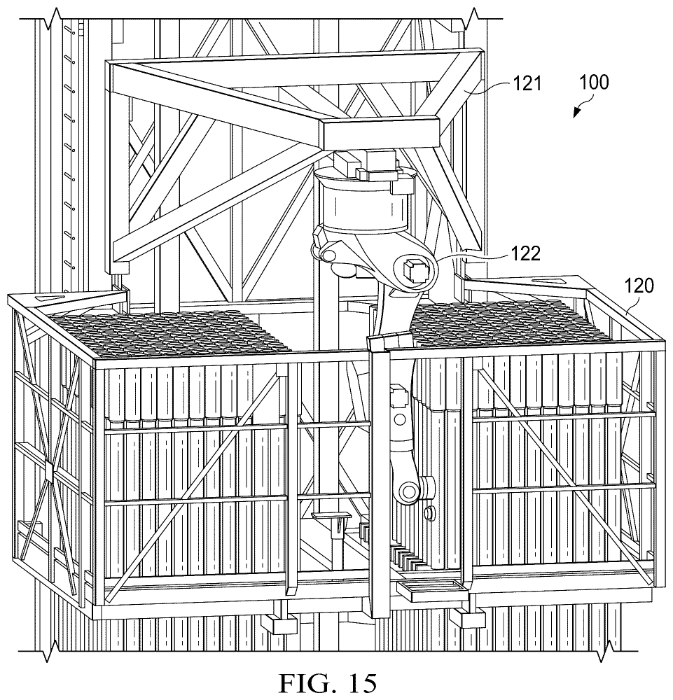

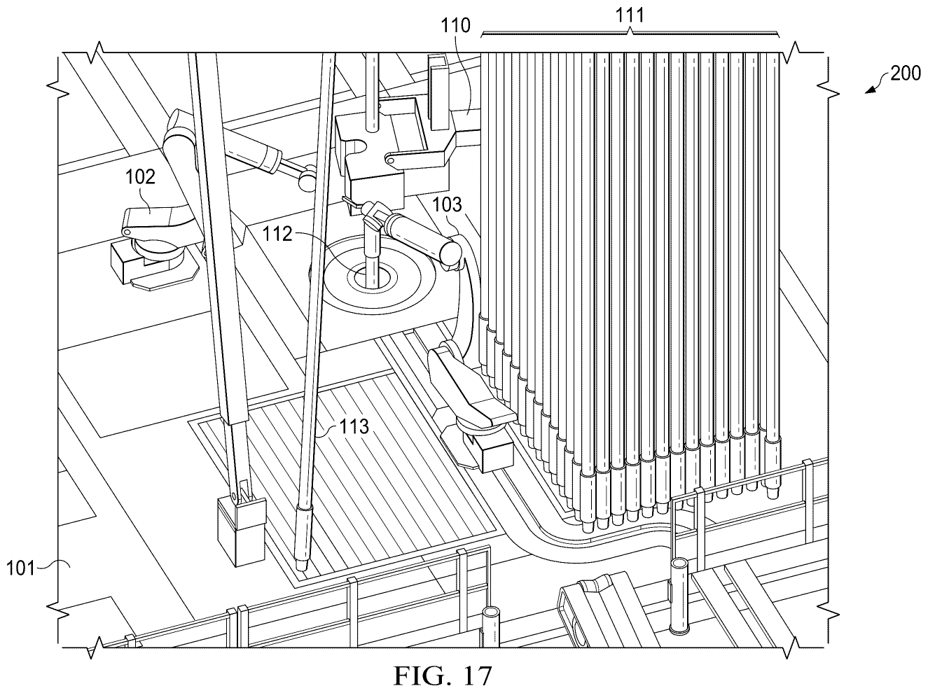

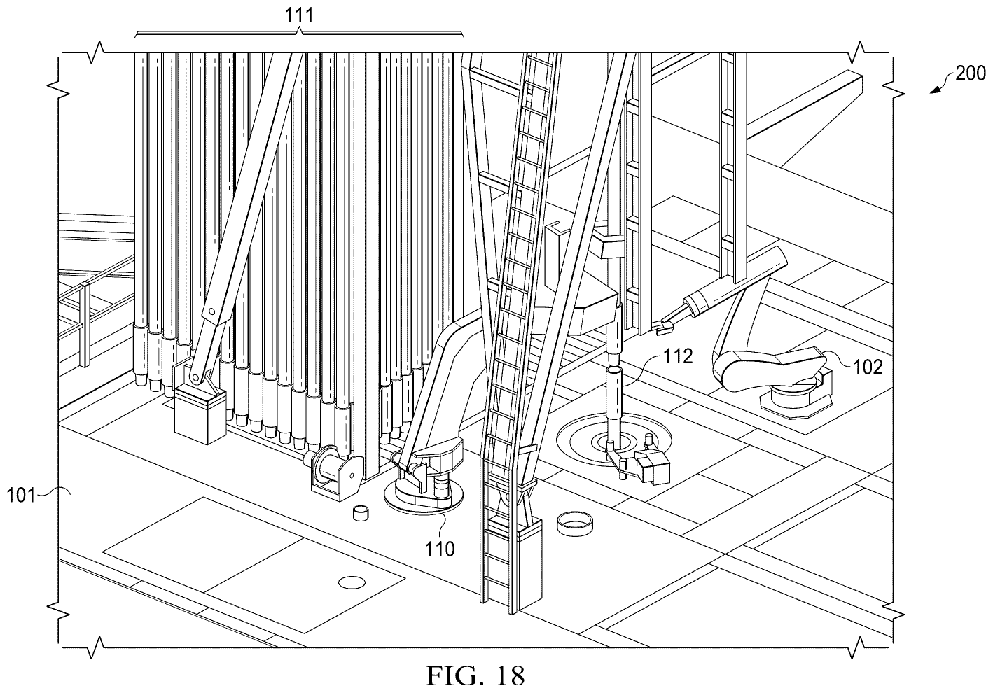

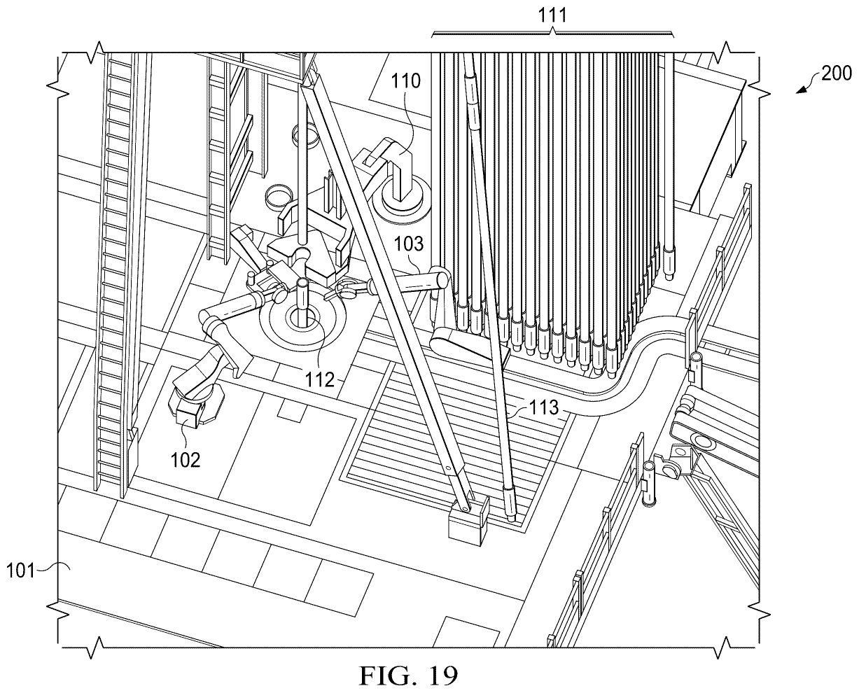

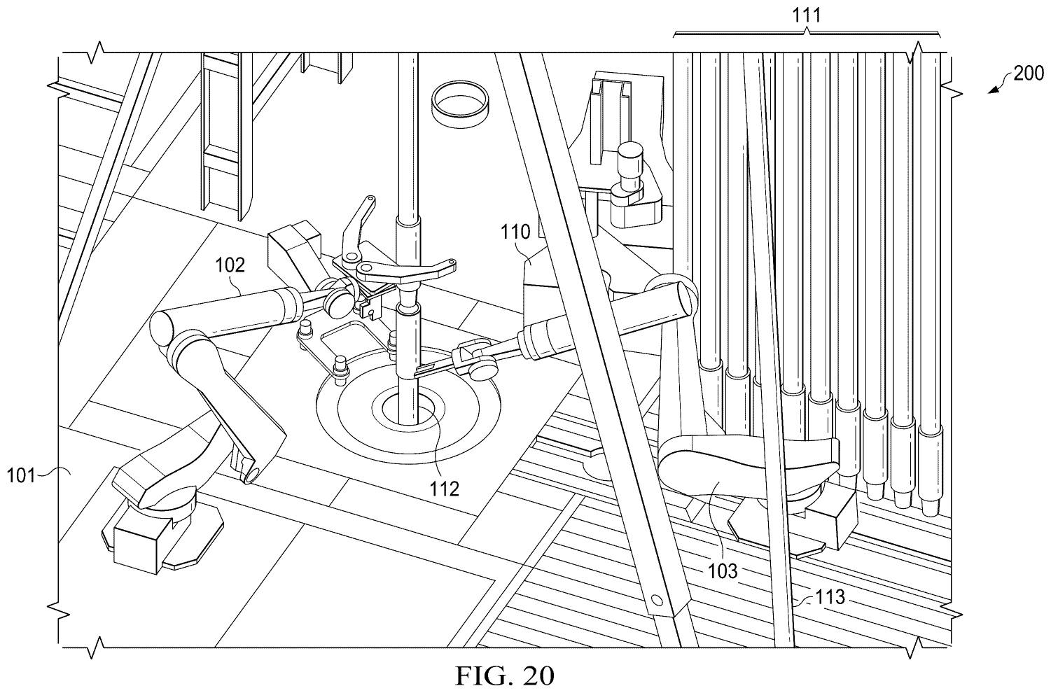

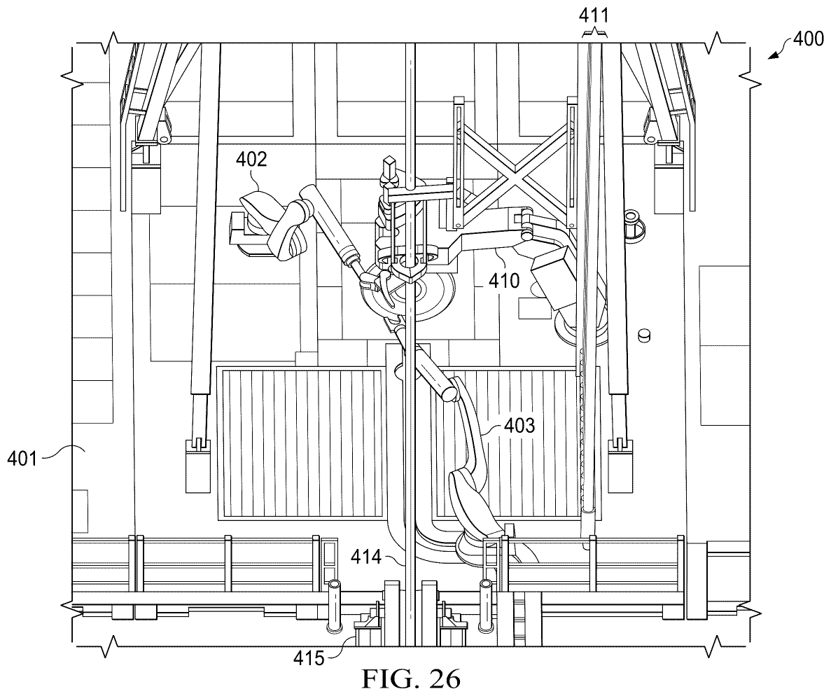

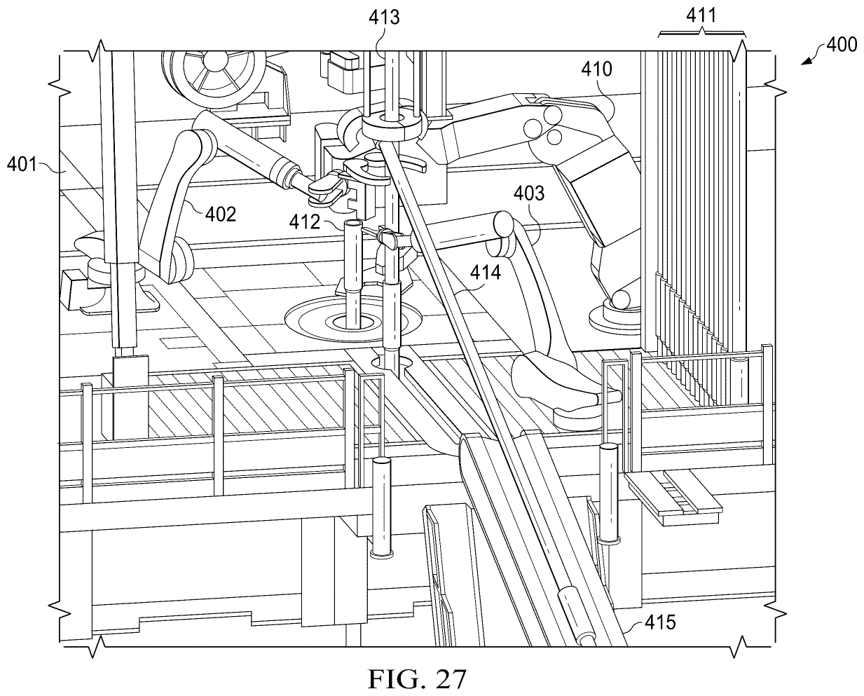

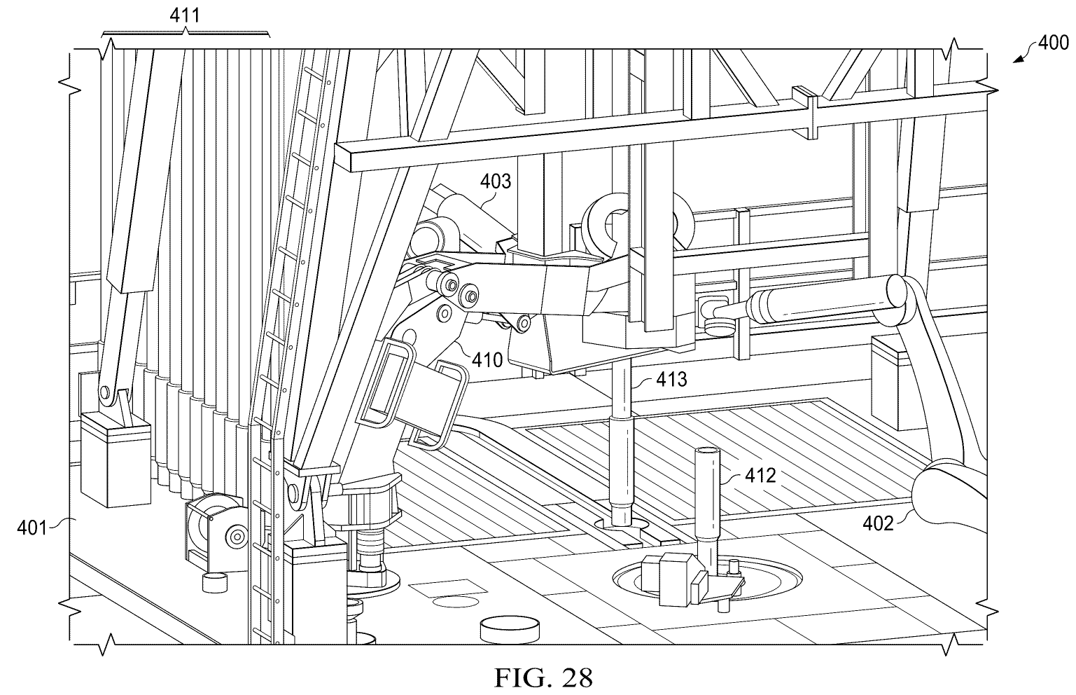

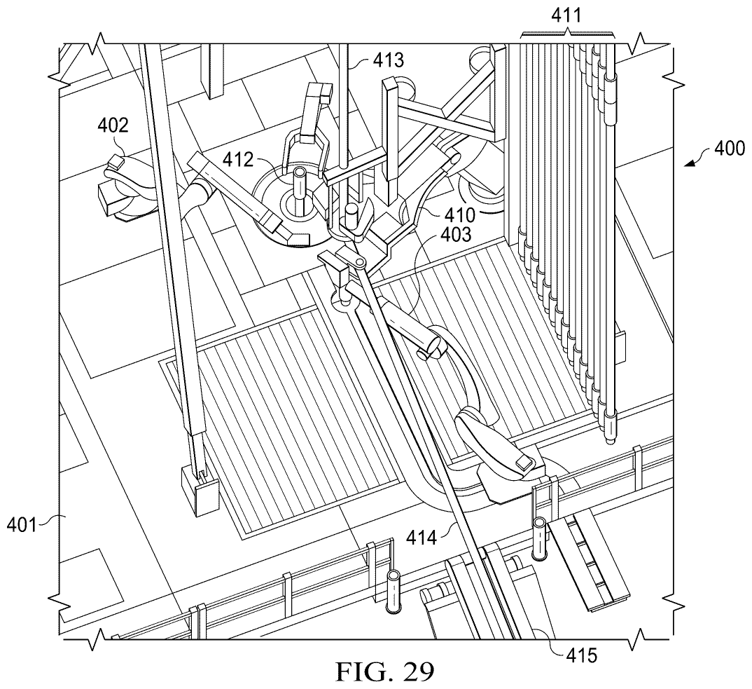

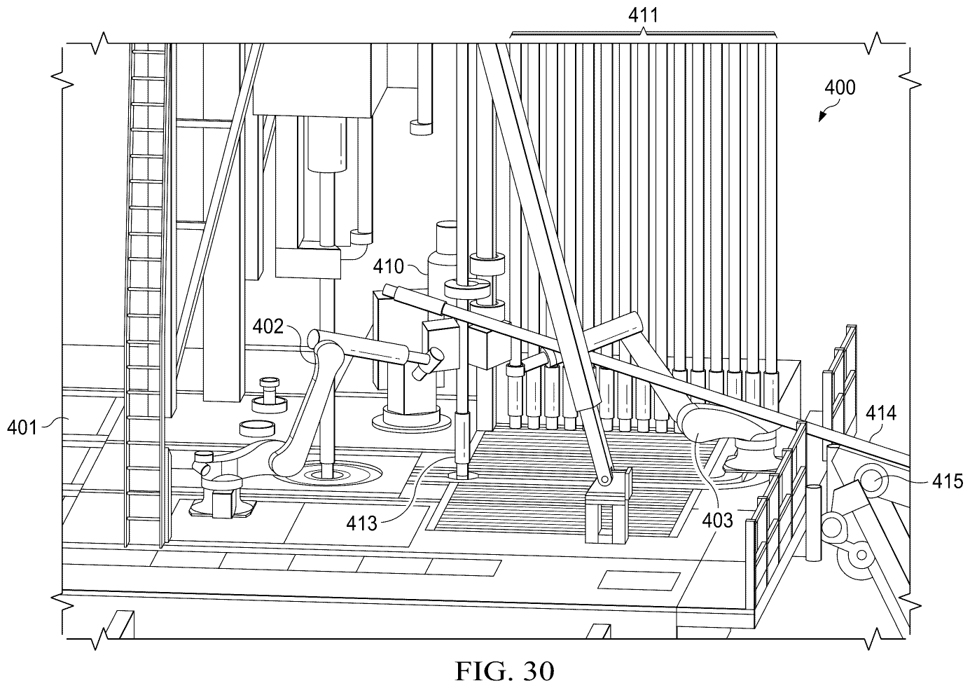

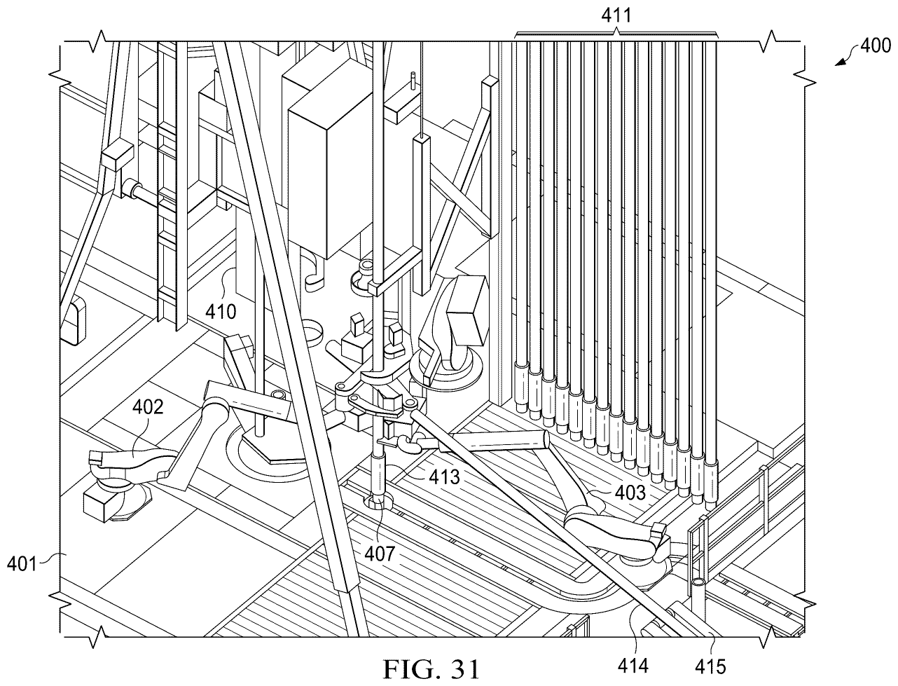

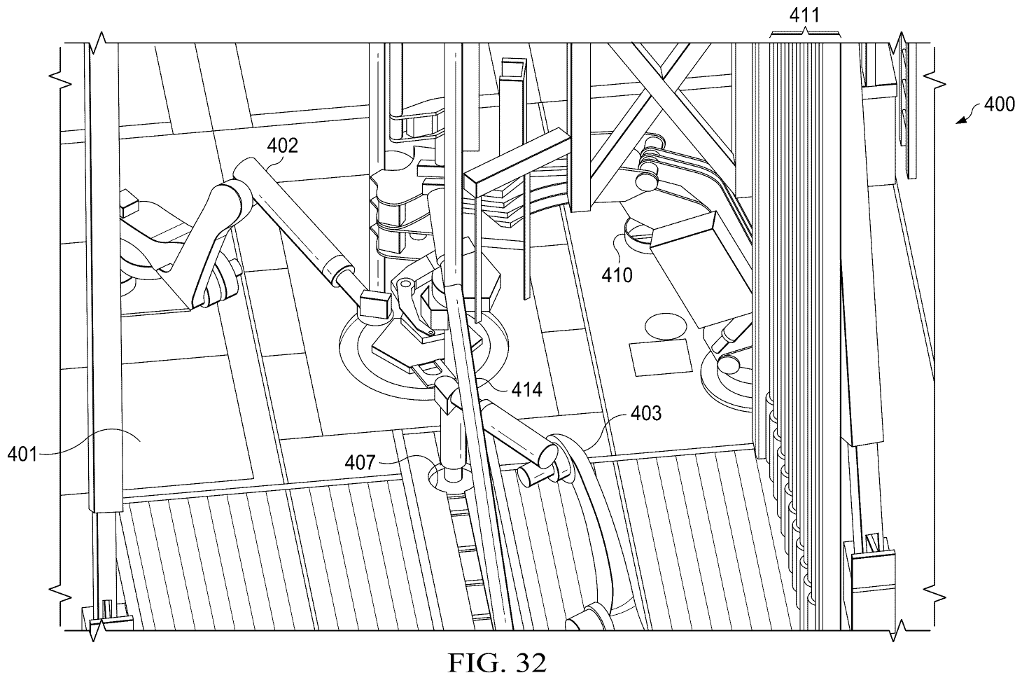

FIGS. 1 through 32, described below, and the various implementations used to describe the principles of the present disclosure are by way of illustration only and should not be construed in any way to limit the scope of this disclosure. Those skilled in the art will understand that the principles of the present disclosure may be implemented in any type of suitably arranged device or system.

As used herein, “tubular” refers to an elongated cylindrical tube and can include any of the tubulars manipulated around a rig, such as tubular segments, tubular stands, tubulars, and tubular string, but not limited to the tubulars shown in the figures. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

Drilling rig “red zones” have traditionally been particularly hazardous workspaces in the oil and gas industry. As noted above, robotic mechanisms may be deployed to replace humans on the rig floor and racking board, such as Atom RTX systems proposed by National Oilwell Varco (NOV). A better example of a potentially suitable rig floor automation systems are red zone robotics (RZR) modules available from Nabors Industries. For instance, the Canrig® RZR Rig Floor automates pipe handling to remove crews from red zone areas while providing full control over tubular handling from the drillers cabin and delivering consistent performance. With such safe, hands-free pipe handling, floor hands and derrick hands can be relocated from red zone areas. Coupled with autonomous triple racking tubular handling having electric axes and a gripper (e.g., hydraulic or mechanical), the system enables completely hands-free pipe handling and both online and offline stand building.

Utilization of standard industrial handling robots in rig floor automation systems has the potential to reduce costs. Examples of such standard industrial handling robots include those available from any of ARC Robotics, Kuka AG, or Regal Robotics. However, commercially available standard industrial handling robots typically have payload limits on the order of hundreds of kilograms (kg). Assembled tubulars within a drilling rig column racker system may have a weight much higher—even up to several times—that payload limit. Assembled tubulars also exhibit a large moment for movement from horizontal to vertical orientation due to the associated length and gripping position.

In the present disclosure, standard industrial handling robots are utilized for rig floor automation, with the structure of and processes employed on the drilling rig system adapted to accommodate limitations of the standard industrial handling robots. In the systems utilizing standard industrial handling robots according to the present disclosure, at least one of the industrial handling robots may be capable of handling weights of a single joint tubular to assist in stand-building. An automated self-elevating mouse hole is optionally used, to assist the industrial handling robots in stand-building. At least one of the industrial handling robots is mounted on a track so that, when not being utilized, the industrial handling robot may be moved out of the way to enable traditional manual operations. The catwalk includes hydraulic ramp angle adjustment and push-skate, which can assist in increasing the angle of the tubular to reduce moment on the industrial handling robot and push the tubular further through the gripper, thereby assisting in tubular handling off the catwalk.

FIGS. 1, 2, 3, 4, 7, and 8 are perspective views, and FIGS. 5 and 6 are side elevation views, individually and collectively illustrating one or more aspects of a drilling rig apparatus in accordance with the present disclosure. The embodiment illustrated in FIGS. 1 through 8 is for illustration and explanation only. FIGS. 1 through 8 do not limit the scope of this disclosure to any particular implementation.

The drilling rig apparatus 100 in FIGS. 1 through 8 is intended for automated tubular handling utilizing standard industrial handling robots on a drilling rig. Suitable drilling rigs and associated tubular handling systems that may be adapted as described herein are illustrated and described in any one or more of U.S. Patent Application Publication No. 2016/0060980, U.S. Patent Application Publication No. 2018/0030788, U.S. Patent Application Publication No. 2019/0330933, U.S. Patent Application Publication No. 2019/0024465, U.S. Patent Application Publication No. 2020/0123861, U.S. Patent Application Publication No. 2020/0308916, U.S. Patent Application Publication No. 2020/0199949, or U.S. Patent Application Publication No. 2023/0104068. The content of those patent documents is incorporated herein by reference.

The drilling rig apparatus 100 is employed for drilling operations and casing operations. Drilling and casing operations involve manipulating, assembling, and breaking down drilling components such as drill pipe (forming a drill string) and casing. During drilling and casing operations, casing is inserted into a borehole at periodic intervals as the borehole is drilled. Each time another stand of casing needs to be lowered into the borehole, the drill string is tripped out of the borehole, and a stand of casing (assembled from casing tubulars) is inserted. Stands of casing may be assembled ahead of time and stored in a casing racking board. As the drill string is tripped out of the borehole, the drill string is broken down into stands and set aside, for example in a drill pipe racking board. After the casing is inserted into the borehole, the drill string is reassembled and tripped back into the borehole.

During drilling, the drill pipe may be assembled into a drill string that is connected to and rotated by a top drive (carried by the mast) and may terminate in a bottom hole assembly (BHA), which includes a drill bit lowered through the installed casing. In some implementations, the drill string may include one or more subs or other components. The drill string may be formed from a plurality of tubular stands that are assembled on the drilling rig floor 101 before being lowered into a wellbore through a well center in the drill floor, and into the installed casing. In some implementations, the drilling rig may be a mobile, land-based drilling rig.

In embodiments of the present disclosure, the drilling rig apparatus 100 includes two standard industrial handling robots 102, 103 secured to the drilling rig floor 101. Industrial handling robots 102, 103 are not custom-made for use on a drilling rig, but are commercially available, programmable industrial handling robots designed for use in a variety of manufacturing or other industrial applications such as: materials handling; picking, packing, and/or palletizing; assembly; machine tending (including loading of raw materials form processing, unloading, and overseeing the machine); mechanical cutting, grinding, deburring, and polishing; welding; and the like. The industrial handling robots 102, 103 are equipped with suitable gripping attachments for handling tubulars. However, neither of industrial handling robots 102 nor robot 103 is customized for the weight and/or cumbersome nature of such tubulars. Instead, drilling rig structures around the industrial handling robots 102, 103 are adapted to allow the industrial handling robots 102, 103 to perform tubular handling. Accordingly, the term “industrial handling robot” (or, equivalently, “standard industrial handling robot”) is used herein to refer to commercially available, programmable industrial handling robots that are not specifically customized for the weight and/or cumbersome nature of handling tubulars on a drilling rig, even when equipped with suitable gripping attachments for handling tubulars. In particular, the term “industrial handling robot” refers to systems capable of handling the weight of tubulars or stands but not specifically designed for or capable of handling the combined weight and rotational moment (a/k/a moment of inertia and/or torque) of tubulars or stands that are gripped near one end and rotated from a substantially horizontal orientation to a substantially vertical orientation or vice versa. As described in further detail below, drilling rig structures around the industrial handling robots 102, 103 are adapted to limit the rotation of tubulars or stands from a substantially vertical orientation. With such orientations (e.g., no more than about 40° from the vertical, optionally less and as little as 5° to 10° from a vertical relative to the direction of gravitational forces on the tubulars or stands being handled), the moment of inertia on the tubulars or stands being handled is limited and kept within the capabilities of standard industrial handling robots capable of handling the weight.

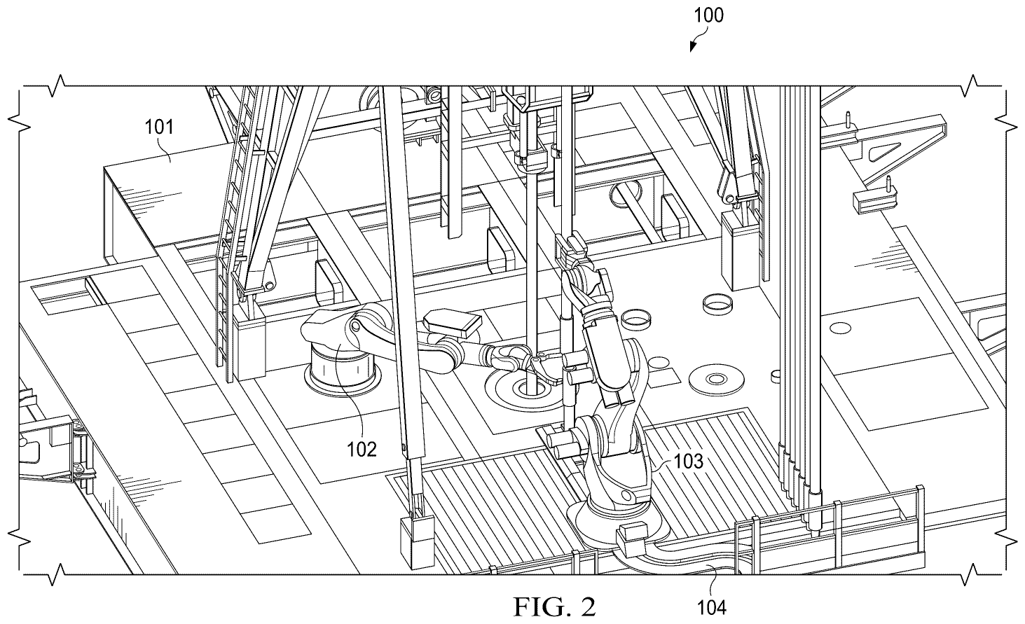

One adaptation of the drilling rig in the drilling rig apparatus 100 involves mounting at least one of the robots on a track. One industrial handling robot 102 may be secured to the drilling rig floor 101 at a fixed position. That industrial handling robot 102 may be retracted, when not in use, into the smallest possible or least obstructive footprint. The other industrial handling robot 103 is movably mounted on a track 104. The movable industrial handling robot 103 slides along a slot in the track 104 or rides between parallel rails forming the track 104. The industrial handling robot 103 is either locked in position or unlocked for movement along the track 104 by a locking mechanism, such as a plurality of threaded bolts and corresponding nuts or (preferably) a electromechanically-controlled braking mechanism engaged and inhibiting movement of the industrial handling robot 103 when loads are lifted and moved by the industrial handling robot 103. Movement extends the operational range of the industrial handling robot 103. In FIG. 2, for example, the fixedly mounted industrial handling robot 102 is extended to almost the limit of horizontal reach for that industrial handling robot 102. In that position, the height above the drilling rig floor 101 to which the industrial handling robot 102 could lift a tubular is limited. This inhibits the usefulness of the industrial handling robot 102 in manipulating a tubular for purposes of stand building. The capability of the track-mounted industrial handling robot 103, however, to move around the drilling rig floor 101 extends both the portion of the area on that drilling rig floor 101 over which the industrial handling robot 103 may operate and the usefulness of the industrial handling robot 103 in manipulating tubulars for assembly and installation.

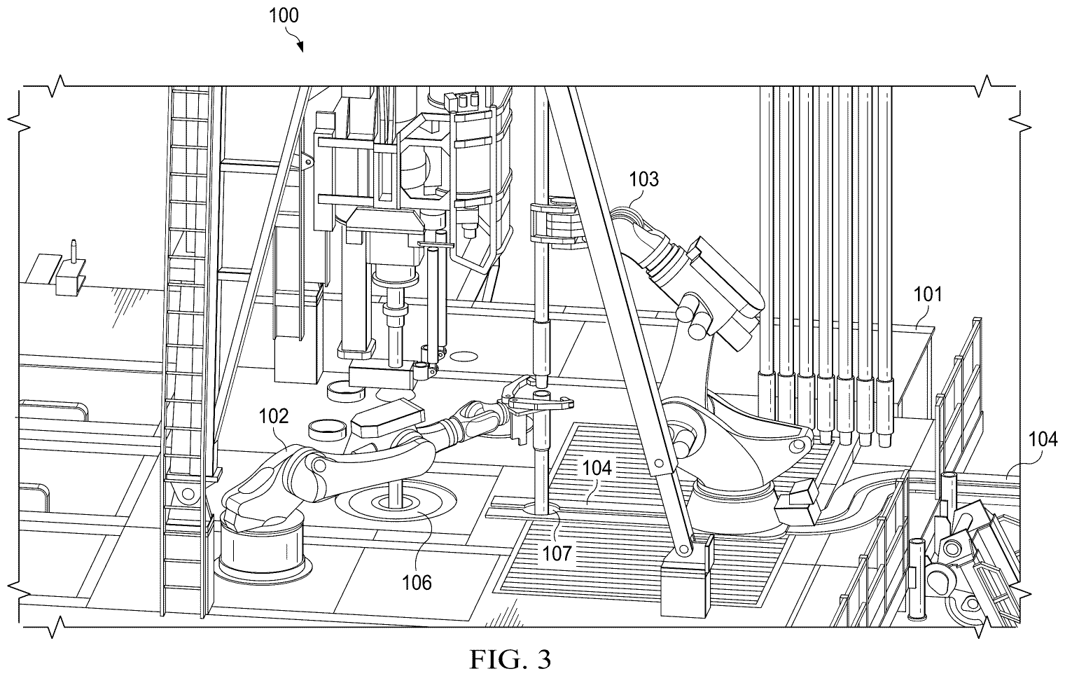

In addition, the drilling rig apparatus 100 of the present disclosure may be designed for both robotic (fully automated) and conventional pipe handling. Accordingly, movably mounting the industrial handling robot 103 on the track 104 allows that industrial handling robot 103 to be moved out of the way in case (for instance) operation of the drilling rig apparatus 100 must be temporarily halted so that manual operations may be performed. As apparent from the generally L-or S-shaped example of a robot path (or “alley”) that is depicted (best seen in FIGS. 1 and 3), the track 104 allows the robot 103 to be “parked,” moved out of the way of any conventional, manual operations involving one or more of the catwalk 105, the rotary table 106, and/or the mousehole 107. Optionally, the robot 103 may be moved completely off the drilling rig floor 101.

Since the drilling rig apparatus 100 of the present disclosure is designed for both automated and conventional pipe handling, the back link is also adjustable between robotic and manual pipe handling controls.

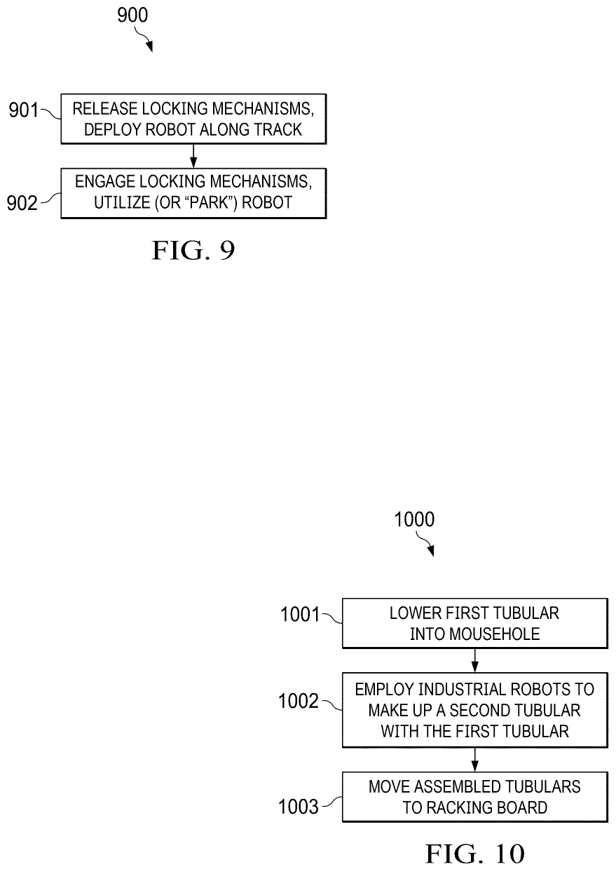

FIG. 9 is a high level diagram for a process of employing at least one movable industrial handling robot 103 on the drilling rig apparatus 100 in accordance with the present disclosure. The embodiment illustrated in FIG. 9 is for illustration and explanation only. FIG. 9 does not limit the scope of this disclosure to any particular implementation.

In the process 900, the locking mechanism(s) for the movable industrial handling robot 103 are released and the movable industrial handling robot 103 is deployed along a track 104 on which that movable industrial handling robot 103 is mounted (step 901). For instance, FIGS. 1-3 and 8 illustrate the movable industrial handling robot 103 being moved from a first position along the track 104 to a second position. At the first position (shown in FIGS. 1-3), the movable industrial handling robot 103 is employed in conjunction with fixed industrial handling robot 102. for automated drilling operations, such as making up tubular stands. Once the movable industrial handling robot 103 is moved along the track 104 to the second position, the locking mechanism(s) for the movable industrial handling robot 103 are re-engaged and the movable industrial handling robot 103 is employed at the second position for other automated drilling operations (step 902), such as removing tubulars from the catwalk 105 that lifts tubulars from a pipe staging area 108. As illustrated in FIGS. 1, 3, and 5, however, the track 104 may include a portion projecting off the drilling rig floor 101. The movable industrial handling robot 103 may be moved onto that projecting portion of the track 104, to be effectively parked out of the way while manual drilling operations are performed. Accordingly, the movable industrial handling robot 103 may be simply parked at the second position, once moved.

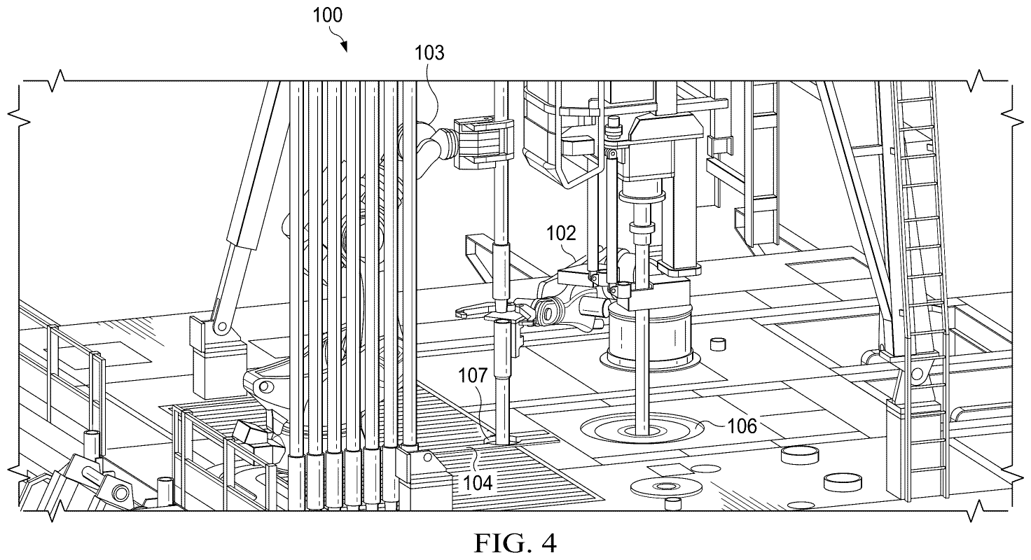

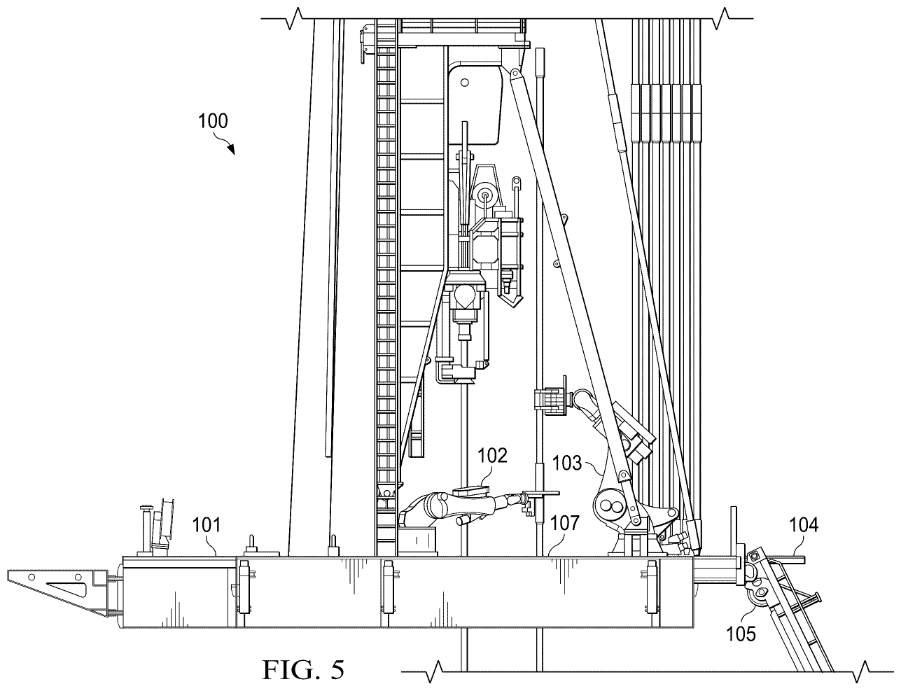

A second adaptation of the drilling rig in the drilling rig apparatus 100 involves controlling the industrial handling robot 102 and the industrial handling robot 103 to pick and build tubular stands. In that respect, a mousehole 107 in the drilling rig floor 101 receives and holds a first tubular while the industrial handling robots 102 and 103 operate in conjunction with each other to assemble a second tubular to the first tubular (best seen in FIGS. 3 and 4). Exemplary mousehole systems that may be employed as described herein are illustrated and described in at least U.S. Patent Application Publication No. US 2016/0168928, the content of which is incorporated herein by reference. When the current drill string has reached a depth at which additional tubulars are necessary to further advance the drill string, the assembled stand of tubulars within the mousehole 107 may be connected to the top drive and added to the existing string. For purposes of stand assembly and connection to an existing drill string, the mousehole 107 may be powered (or “automated”), having an elevating bottom, a pipe spinner, or both. The mousehole 107 (best seen in FIGS. 1, 3-5, and 8) may be a telescoping, powered mousehole that moves tubular stands held therein up and down during assembly, in order to adjust the height of a tubular assembly being held and/or assembled. The mousehole 107 may include a centralizer keeping the tubular centered inside the mousehole.

In the present disclosure, the mousehole 107 moves tubulars to facilitate grasping of the tubular (or tubular assembly) held therein by the industrial handling robots 102 and 103, as well as assembly of additional tubular lengths (e.g., up to three lengths may be assembled offline). Industrial handling robots 102 and 103, in conjunction with mousehole 107, assembles tubulars in a manner similar to the iRacker within the Canrig® RZR Rig Floor identified above, but using commercially-available industrial handling robots 102 and 103. Assembled tubular stands held within the mousehole 107 may be lifted by a top drive for assembly with the string in the borehole. Assembled tubular stands may also be moved to a racking board (not shown in FIG. 1-8, but described in further detail below), such as a dual racking board holding assembled drill pipe in one portion and assembled casing in another portion.

FIG. 10 is a high level diagram for a process of employing industrial handling robots 102 and 103 on the drilling rig apparatus 100 to make up tubular assemblies in accordance with the present disclosure. The embodiment illustrated in FIG. 10 is for illustration and explanation only. FIG. 10 does not limit the scope of this disclosure to any particular implementation.

In the process 1000, a first tubular is lowered into the mousehole (step 1001). The industrial handling robots 102 and 103 are then utilized to make up a second tubular with the first tubular (step 1002), forming an assembly of the tubulars. These two steps may be repeated with additional tubular(s), to form assemblies of three tubulars as described above. Once the number of desired lengths have been assembled, the assembled tubulars are moved to a rack board (step 1003).

A third adaptation of the drilling rig in the drilling rig apparatus 100 involves the position of the catwalk 105 when a tubular is removed from the catwalk 105 by the industrial handling robot 103. Exemplary catwalk systems that may be adapted and employed as described herein are illustrated and described in at least U.S. Patent Application Publication No. US 2020/0123861, the content of which is incorporated herein by reference. The catwalk 105 is an elongated platform—typically hydraulic and/or telescoping—on the side of the drilling rig on which the pipe staging area 108 is located. The catwalk 105 is employed in lifting pipe onto the drilling rig floor 101 from the pipe staging area 108, for assembly into tubular stands that are held until needed on the racking board. Often, the orientation of the catwalk 105 in conventional operations may be closer to the horizontal (e.g., about 75° from the vertical) than the vertical when a tubular is lifted off the catwalk 105.

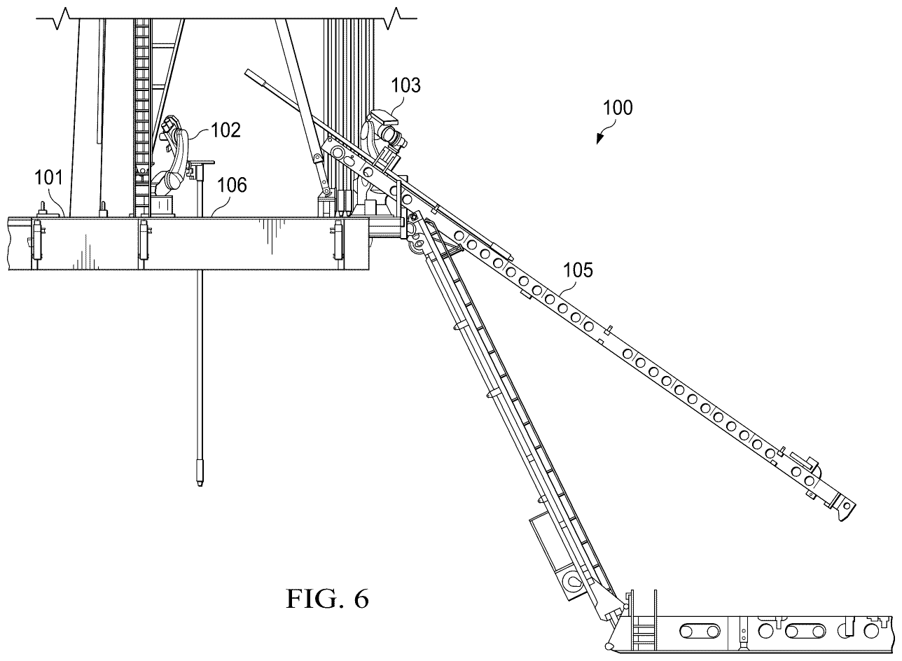

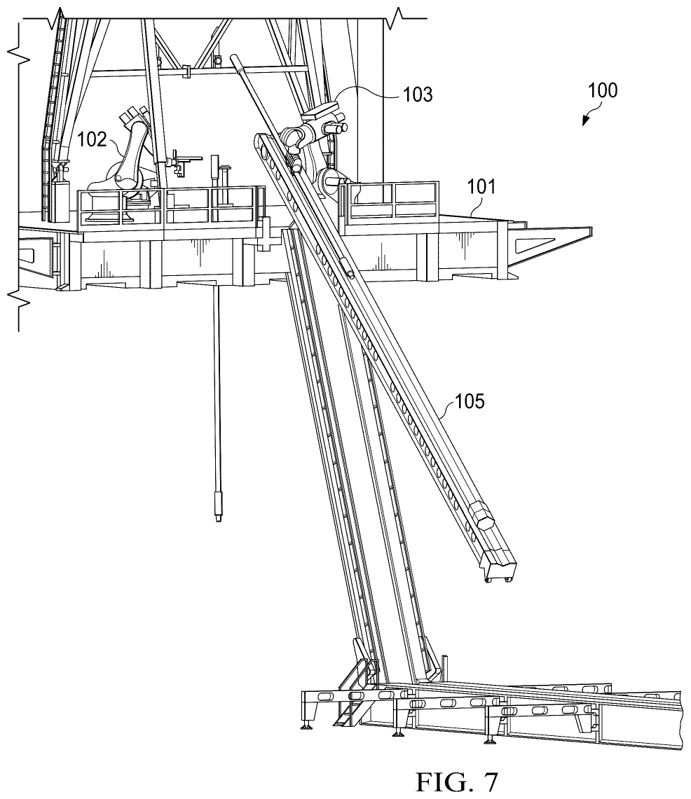

In the present disclosure (best seen in FIGS. 6 and 7), the orientation of the catwalk 105 is closer to the vertical than horizontal (e.g., about 35°-40° or less from the vertical, and as little as 5°-10°) when the tubular on the catwalk 105 is lifted off by the industrial handling robot 103. The industrial handling robot 103 therefore sees substantially less moment in moving the tubular to a generally vertical orientation from the catwalk 105, before that tubular is also grabbed by the industrial handling robot 102 as part of guiding the tubular toward the wellhead (at the rotary table 106) or the mousehole 107. That is, adjustment of the feed-angle for the catwalk 105 reduces torque on the industrial handling robot and help with stand building. The orientation of the catwalk 105 may also be adjusted after the industrial handling robot 103 has grasped the tubular thereon, to facilitate movement of the tubular to a generally vertical orientation.

A fourth adaptation of the drilling rig in the drilling rig apparatus 100 involves the retention system for tubulars on the catwalk 105. As apparent, the industrial handling robot 103 must grasp a tubular on the catwalk at a position sufficient close to a bottom end of that tubular to allow the bottom end to clear the drilling rig floor 101 as the tubular is rotated to the generally vertical orientation. Accordingly, the tubular retention mechanism on the catwalk 105 continues to at least partially secure the bottom end of the tubular against counterrotation as the tubular is grasped by the industrial handling robot 103 and lifted off the catwalk 105. That tubular retention mechanism on the catwalk 105 may also contribute to further elevation of the tubular after the tubular is grasped by the industrial handling robot 103, to reduce the moment on the industrial handling robot 103. A combination of elevations of the tubular retention mechanism on the catwalk 105 and adjustment of the angle of the catwalk 105, in conjunction with grasping and lifting of the tubular by the industrial handling robot 103, may facilitate transition of tubular from being supported by the catwalk 105 to being held in a generally vertical orientation by the industrial handling robot 103, for movement toward the wellhead or the mousehole 107.

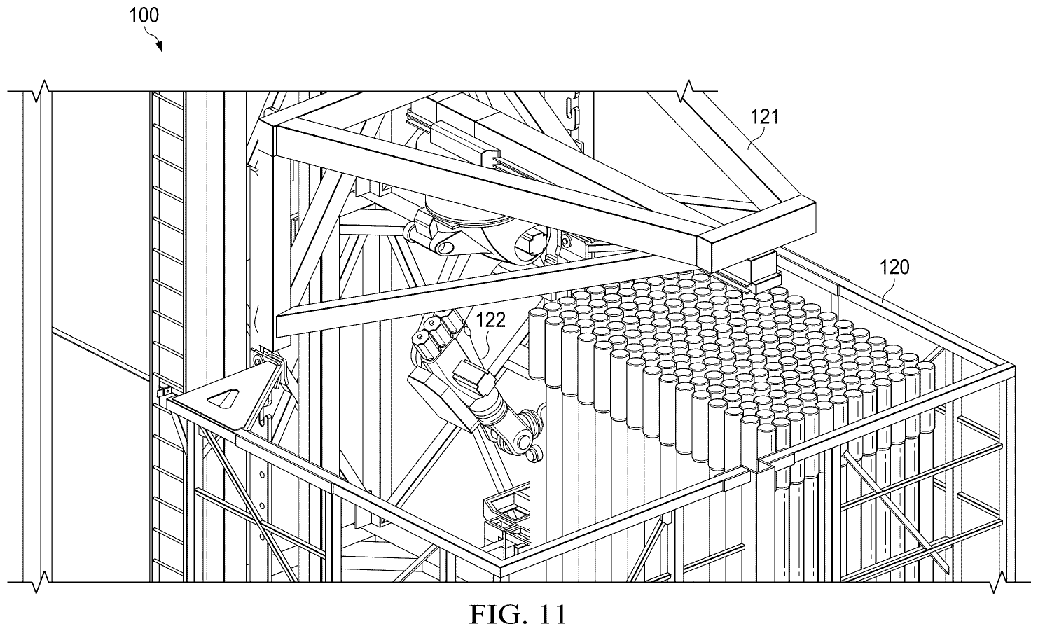

FIGS. 11-12 and 14-15 are perspective views, and FIG. 13 is a side elevation view, individually and collectively illustrating one or more aspects of a drilling rig apparatus in accordance with the present disclosure. The embodiment illustrated in FIGS. 11 through 15 is for illustration and explanation only. FIGS. 11 through 15 do not limit the scope of this disclosure to any particular implementation.

The drilling rig apparatus 100 in FIGS. 1 through 8 may, as illustrated in FIGS. 11 through 15, include a racking board. FIGS. 1-8 depict lower views of the drilling rig apparatus 100 while FIGS. 11-15 depict counterpart upper views, for tubular racking/unracking operations. Exemplary racking board systems that may be adapted and employed as described herein are illustrated and described in at least U.S. Patent Application Publication No. US 2020/308916, the content of which is incorporated herein by reference. A dual layer racking board 120 may be secured to the mast for the drilling rig apparatus 100 to support assembled tubulars in a generally vertical orientation on the drilling rig floor 101. As shown in FIGS. 11 through 15, a support 121 is affixed to the mast for the drilling rig apparatus 100 for a third industrial handling robot 122 that is—like industrial handling robots 102 and 103—a commercially available, programmable industrial handling robot equipped with suitable gripping attachments for handling tubulars but not customized for the weight and/or cumbersome nature of such tubulars. As illustrated by FIGS. 11 through 15, the industrial handling robot 122 is inverted, and is employed in moving tubulars into, within, and out of the racking board 120. The industrial handling robot 122 may be mounted on a track similar to track 104 and industrial handling robot 103, or may be otherwise mounted to be stoved (shifted aside) to allow for manual operation.

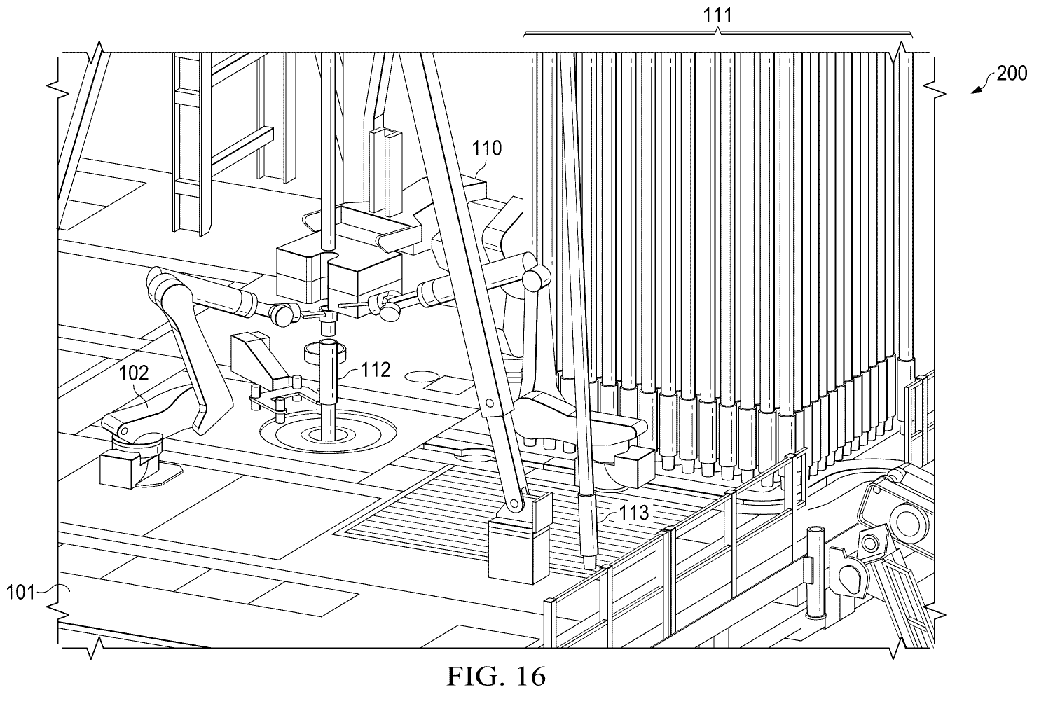

FIGS. 16-22 individually and collectively illustrating one or more aspects of utilizing standard industrial handling robots for tripping and for racking/unracking on a drilling rig apparatus in accordance with the present disclosure. The embodiments illustrated in FIGS. 16 through 22 are for illustration and explanation only. FIGS. 16 through 22 do not limit the scope of this disclosure to any particular implementation.

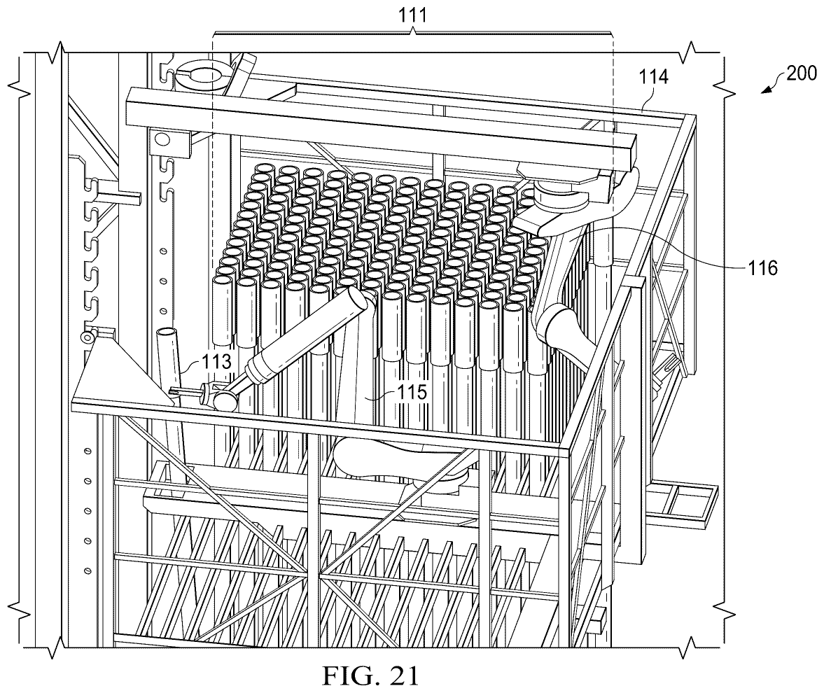

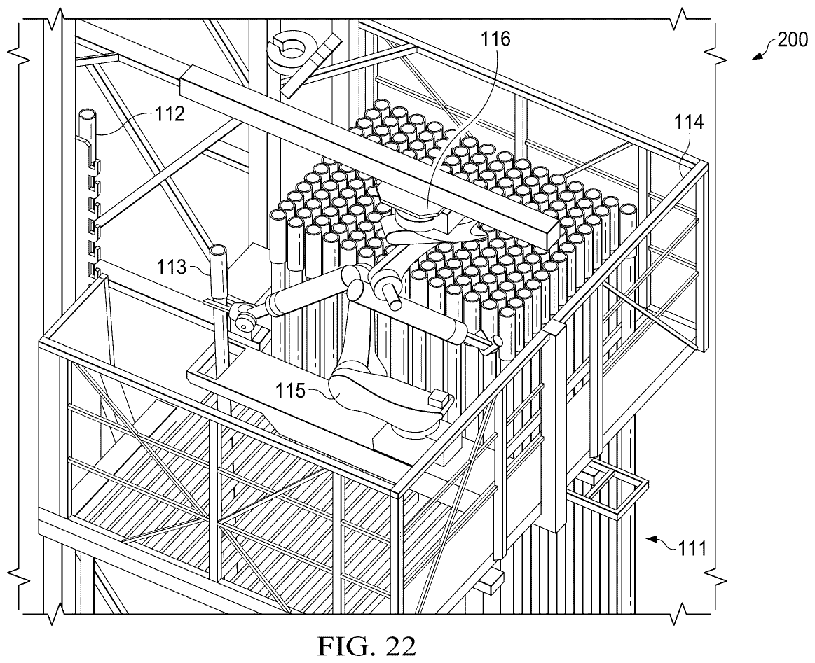

FIGS. 16-20 depict lower views of the drilling rig apparatus 200 while FIGS. 21-22 depict counterpart upper views, for tubular tripping operations or racking/unracking operations. In the example shown, an additional tubular handling robot 110 is mounted on the drilling rig floor 101. The tubular handling robot 110 is not necessarily an industrial handling robots, as are industrial handling robots 102 and 103. That is, the tubular handling robot 110 may be specifically designed or customized for the weight and/or cumbersome nature (moment of inertia) of handling tubulars or stands on a drilling rig. Such tubular handling robots are commercially available and include, for example, the Canrig® RZR Rig Floor systems mentioned above. In some embodiments, the tubular handling robot 110 may be simply more capable of handling tubulars and stands, when operated alone, than either of the industrial handling robots 102 and 103, without necessarily being fully capable of handling all required operations without the industrial handling robots 102 and 103.

FIGS. 16-20 are various views of the tubular handling robot 110 being operated in conjunction with the industrial handling robots 102 and 103 to perform tripping operations, either unracking stands and running those stands into the borehole or removing stands from the borehole and racking the removed stands. FIGS. 16-20 illustrate a stand 112 being run into or removed from the borehole, and a stand 113 being substantially concurrently unracked from or racked to the racked stands 111, by the tubular handling robot 110 operating in conjunction with the industrial handling robots 102 and 103. Thus, for example, at different points in time the tubular handling robot 110 and the industrial handling robot 102 may be making up a recently unracked stand with a stand already in the borehole while the industrial handling robot 103 is engaged in unracking another stand.

As illustrated in FIGS. 16-20, the location of the tubular handling robot 110 on the drilling rig floor 101 is selected, either alone or in conjunction with selection of a range of movement for the tubular handling robot 110, to complement the handling capabilities of the industrial handling robots 102 and 103. Accordingly, the addition of the tubular handling robot 110 to the industrial handling robots 102 and 103 may increase the speed at which tripping operations may be completed.

The tubular handling robot 110 is illustrated as secured in a fixed position on the drilling rig floor 101, in some embodiments the tubular handling robot 110 may be track-mounted in a manner similar to industrial handling robot 103. Moreover, the tubular handling robot 110 may be selectively mounted on the drilling rig floor 101 to operate in conjunction with the industrial handling robots 102 and 103 for only limited periods of time, and may be moved to other rigs when operations can be performed with acceptable efficiency using only the industrial handling robots 102 and 103.

FIGS. 21-22 are various views of tubular handling with multiple industrial handling robots 115, 116 mounted on or proximate to the racking board 114. The racking board 114 is analogous to the racking board 120 described above, and industrial handling robot 116 is analogous to industrial handling robot 122, mounted in an inverted position in a manner allowing the industrial handing robot 116 to reach, grasp, and rack/unrack stands in the racking board 114. However, as apparent, the configuration of the racking board 114 is somewhat different than the configuration of racking board 120. Accordingly, in some embodiments an additional industrial handling robot 115 may be mounted near the top of the racking board 114 and operated cooperatively with the industrial handling robot 116 in racking/unracking tubulars to/from the racked stands 111. As depicted in FIGS. 21-22, the additional industrial handling robot 115 may be mounted with an orientation and/or at a position that is complementary to the mounting of the industrial handling robot 116, to increase the ranges of movement across which tubulars or stands may be moved by cooperation operation of the two robots.

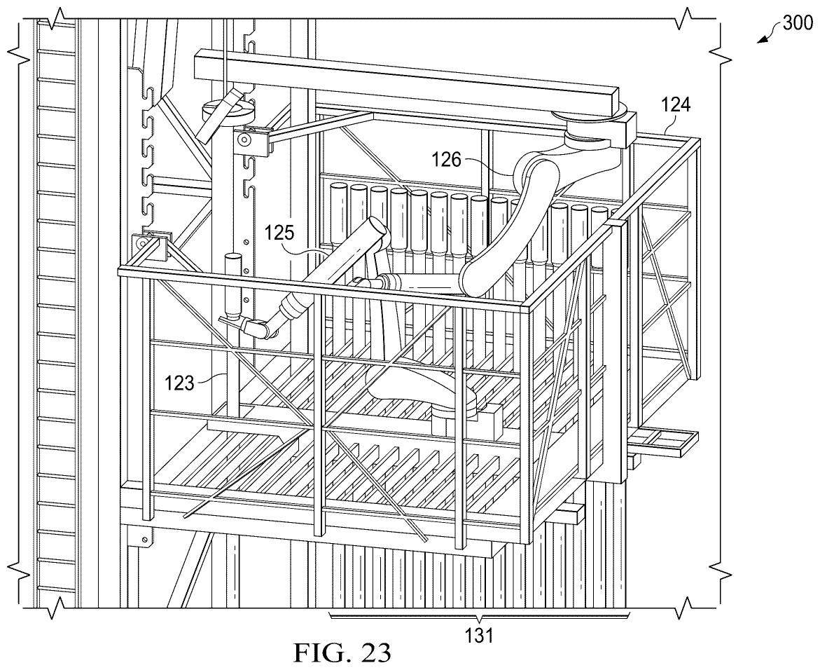

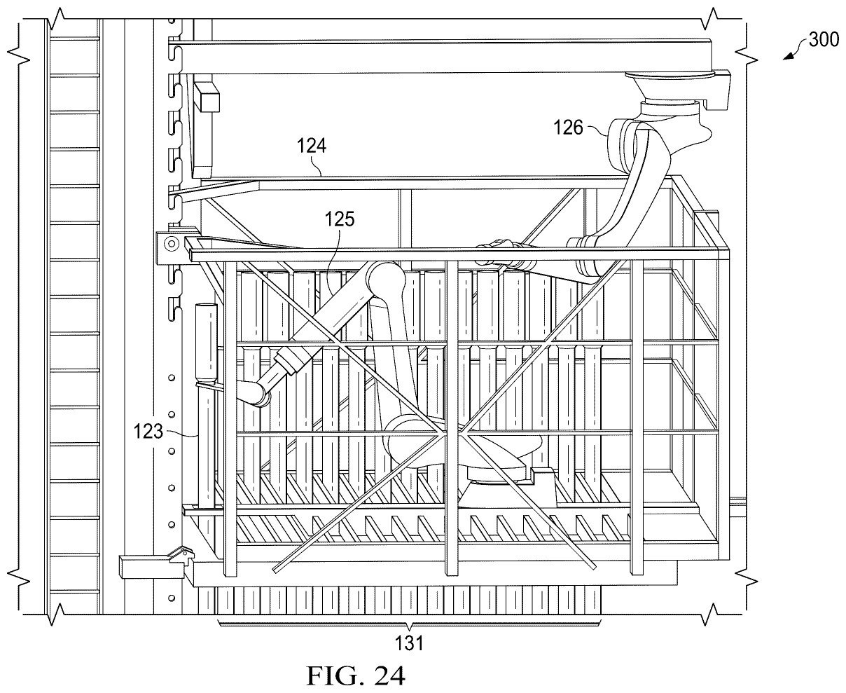

FIGS. 23-24 individually and collectively illustrating one or more aspects of utilizing standard industrial handling robots in an alternative configuration for tripping and racking/unracking on a drilling rig apparatus in accordance with the present disclosure. The embodiments illustrated in FIGS. 23 through 24 are for illustration and explanation only. FIGS. 23 through 24 do not limit the scope of this disclosure to any particular implementation.

FIGS. 23-24 depict views analogous to those in FIGS. 21-22, for a different configuration of a drilling rig apparatus 300. Some drilling rig configurations may have tight clearance to the top drive used during makeup and run-in of tubulars. Accordingly, the space both for movement of a tubular 123 that is being racked/unracked and for racked tubulars 131 may be limited. The positions and orientations in which the industrial handling robots 125, 126 are mounted may be constrained by that availability of space, given the clearance limitations relative to the top drive.

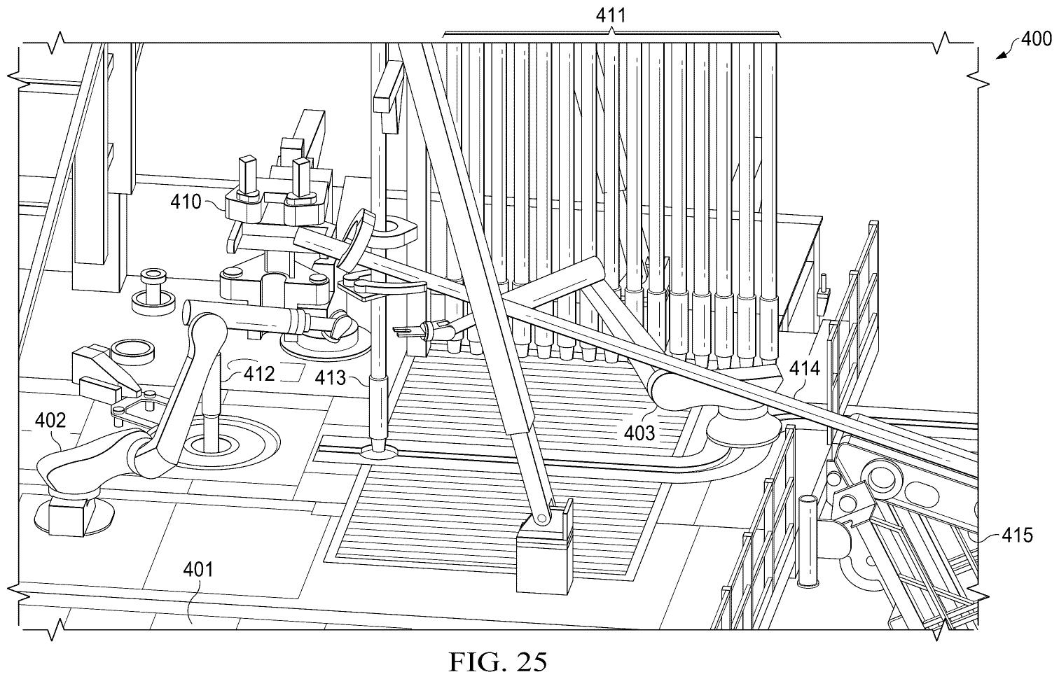

FIGS. 25-32 individually and collectively illustrating one or more aspects of utilizing standard industrial handling robots for stand building on a drilling rig apparatus in accordance with the present disclosure. The embodiments illustrated in FIGS. 25 through 32 are for illustration and explanation only. FIGS. 25 through 32 do not limit the scope of this disclosure to any particular implementation.

Similar to FIGS. 16-20, FIGS. 25-32 illustrate a drilling rig apparatus 400 including two industrial handling robots 402 and 403 and a tubular handling robot 410 positioned on the rig floor 401. The industrial handling robots 402 and 403 and the tubular handling robot 410 may be employed for tripping a tubular 412 and racking/unracking a tubular 413 in the manner described above. As shown in FIGS. 25-32, however, the tubular handling robot 410 may be employed in cooperation with the industrial handling robots 402 and 403 during stand building. In the exemplary embodiment shown in FIGS. 25-32, for instance, the tubular handling robot 410 may receive a tubular 414 being lifted by the elevator 415 from the staging area (not shown) to the rig floor 401. The tubular 414 received off the elevator 415 is assembled with a tubular 413 held by the mousehole 407 as part of forming a stand. Assembled stands are then stored with the racked stands 411. During stand assembly, the equipment used in elevating a single joint that has been lifted from the staging area may be pivoted to avoid interference with the top drive while lifting pipe during stand assembly.

Although this disclosure has been described with reference to various example implementations, various changes and modifications may be suggested to one skilled in the art. It is intended that this disclosure encompass such changes and modifications as fall within the scope of the appended claims.

What is claimed is:

1. An apparatus, comprising:
a first industrial handling robot positioned on a drilling rig floor; and
a second industrial handling robot mounted on a track on the drilling rig floor, wherein the track is configured to facilitate movement of the second industrial handling robot between a first position along the track and a second position along the track.

2. The apparatus of claim 1, wherein, in the first position on the drilling rig floor, the second industrial handling robot is employed for handling tubulars.

3. The apparatus of claim 1, wherein, in the first position on the drilling rig floor, the second industrial handling robot is employed for making up a first tubular with a second tubular.

4. The apparatus of claim 1, wherein, in the second position on the drilling rig floor, the second industrial handling robot is employed for removing a tubular from a catwalk or placing the tubular onto the catwalk.

5. The apparatus of claim 1, wherein the second position on the drilling rig floor allows manual operations with tubulars on the drilling rig floor.

6. The apparatus of claim 5, wherein the second position for the second industrial handling robot is located away from drilling rig floor operations.

7. The apparatus of claim 1, wherein movement of the second industrial handling robot on the track increases a working range of the second industrial handling robot.

8. The apparatus of claim 1, wherein the track is a curved track.

9. The apparatus of claim 8, wherein the first position on the drilling rig floor is between a well center and a catwalk and the second position on the drilling rig floor is offset from a path between the well center and the catwalk.

10. The apparatus of claim 1, further comprising:
a powered mousehole, wherein the first industrial handling robot, the second industrial handling robot, and the powered mousehole are employed for making up a first tubular with a second tubular.

11. The apparatus of claim 1, further comprising:
a tubular handling robot positioned on the drilling rig floor and operated cooperatively with the first industrial handling robot and the second industrial handling robot during at least one of tripping, racking, or stand building.

12. An apparatus, comprising:
an industrial handling robot mounted on a drilling rig floor; and
a catwalk configured to lift each tubular from a staging area into position for grasping by the industrial handling robot, wherein the position of a tubular on the catwalk when grasped by the industrial handling robot has an orientation closer to vertical than horizontal.

13. The apparatus of claim 12, wherein an orientation of the tubular on the catwalk when grasped by the industrial handling robot is less than about 35° from vertical.

14. The apparatus of claim 12, wherein an orientation of the catwalk is adjustable as the tubular on the catwalk is removed from the catwalk by the industrial handling robot.

15. The apparatus of claim 12, wherein the catwalk retains a bottom end of the tubular on the catwalk as the tubular on the catwalk is removed from the catwalk by the industrial handling robot, and a push-skate on the catwalk simultaneously shifts the tubular through a gripper while retaining the bottom end to clear the drilling rig floor while the tubular is shifted to a generally vertical orientation.

16. The apparatus of claim 12, further comprising:
a tubular handling robot positioned on the drilling rig floor and operated cooperatively with the industrial handling robot during at least one of tripping and racking and operated cooperatively with the industrial handling robot and the catwalk during stand building.

17. An apparatus, comprising:
a first industrial handling robot mounted on a drilling rig floor;
a racking board mounted to a mast for a drilling rig including the drilling rig floor; and
a second industrial handling robot.

18. The apparatus of claim 17, further comprising:
a third industrial handling robot mounted next to a top of the racking board, wherein third industrial handling robot is one of mounted on a track on the drilling rig floor or mounted to be stoved to allow manual operation.

19. The apparatus of claim 17, further comprising:
a tubular handling robot positioned on the drilling rig floor and operated cooperatively with the first industrial handling robot and the second industrial handling robot during at least one of tripping, racking, or stand building.
